(19) United States
(12) Patent Application Publication
(10) Pub. No.: US 2025/0254330 A1
(43) Pub. Date: Aug. 7, 2025

(54) CONTEXT-ADAPTIVE BINARY ARITHMETIC CODING UPDATE REFINEMENT

(71) Applicant: InterDigital CE Patent Holdings, SAS, Paris (FR)

(72) Inventors: Federico Lo Bianco, Rennes (FR); Franck Galpin, Thorigne-Fouillard (FR); Ya Chen, Rennes (FR); Guillaume Boisson, Pleumeleuc (FR)

(73) Assignee: InterDigital CE Patent Holdings, SAS, Paris (FR)

(21) Appl. No.: 18/855,241

(22) PCT Filed: Apr. 6, 2023
(86) PCT No.: PCT/EP2023/059214

§ 371 Date: Oct. 8, 2024

(30) Foreign Application Priority Data
Apr. 8, 2022 (EP) 22305491.7

(51) Int. Cl. H04N 19/149; H04N 19/13; H04N 19/70; H04N 19/91

(52) U.S. Cl. CPC H04N 19/149; H04N 19/13; H04N 19/70; H04N 19/91

(57) ABSTRACT

A device may obtain a first value for a first binarization symbol associated with video data and a second value for a second binarization symbol associated with the video data. The device may obtain a probability value associated with a third binarization symbol associated with the video data based on the first value, the second value, and a probability value associated with the first binarization symbol. The device may then decode the video data based on the probability value associated with the third binarization symbol. The first, second and third binarization symbols may be for a transform coefficient. In examples, the first, second and third binarization symbols may be associated with a context for entropy decoding. For example, the first, second and third binarization symbols may be associated with an entropy decoding context for decoding the video data using context-based adaptive binary arithmetic coding (CABAC).

### CROSS-REFERENCE TO RELATED APPLICATIONS

This application claims priority to EP Provisional Patent Application No. 22305491.7, filed on Apr. 8, 2022, and entitled “CABAC Update Refinement,” the entirety of which is incorporated by reference as if fully set forth herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for a device configured to obtain a bin value based on a probability value that has been updated based on multiple bin values.

A device (e.g., a decoder) may obtain a first value for a first binarization symbol associated with video data and obtain a second value for a second binarization symbol associated with the video data. The device may obtain a probability value associated with a third binarization symbol associated with the video data based on the first value, the second value, and a probability value associated with the first binarization symbol. The device may then decode the video data based on the probability value associated with the third binarization symbol. In examples, a value of a binarization symbol (e.g., the first value of the first binarization symbol) may be for a syntax element. In some examples, the first, second and third binarization symbols may be for one or more transform coefficients.

In examples, the first, second and third binarization symbols may be associated with a context for entropy decoding. For example, the first, second and third binarization symbols may be associated with an entropy decoding context for decoding the video data using context-based adaptive binary arithmetic coding (CABAC). The probability value associated with the first binarization symbol may be a context probability value associated with the entropy decoding context, and the probability value associated with the third binarization symbol may be an updated context probability value associated with the entropy decoding context. The probability value associated with the first binarization symbol may be used to obtain the first value for the first binarization symbol and the value for the second binarization symbol. The probability value associated with the third binarization symbol may be obtained by updating the probability value associated with the first binarization symbol based on the values for the first and second binarization symbols. The probability value associated with the third binarization symbol may be used to obtain a third value for the third binarization symbol.

In some examples, the device may obtain a predetermined number of values for a first consecutive number of binarization symbols associated with a context for entropy decoding (e.g., the first and the second binarization symbols may be part of the first consecutive number of binarization symbols), entropy decode the first consecutive number of binarization symbols based on a context probability value associated with the context, and entropy decode a second consecutive number of binarization symbols based on an updated context probability value associated with the context. The context probability value may be updated based on the first consecutive number of binarization symbols. The first consecutive number of binarization symbols and the second consecutive number of binarization symbols may not overlap.

The device may obtain a window size associated with the context and obtain the probability value associated with the third binarization symbol further based on the window size. The device may obtain the probability value associated with the third binarization symbol further based on a weighting factor. The weighting factor may be determined using the window size. In some examples, the device may obtain the probability value associated with the third binarization symbol further based on an error that indicates an inconsistency between the obtained second value and the probability value associated with the second binarization symbol.

The second value for the second binarization symbol may be obtained before the probability value associated with the first binarization symbol is updated. For example, the device may refrain from updating the probability value associated with the first binarization symbol until the second value is obtained. The second value for the second binarization symbol may be obtained based on the same probability value associated with the first binarization symbol. The device may continue to obtain a predetermined number of values for a consecutive number of binarization symbols before updating the probability value associated with the first binarization symbol. For example, the device may have obtained a respective value for each of the consecutive number of binarization symbols before updating the probability value associated with the first binarization symbol, and the second binarization symbol is one of the consecutive number of binarization symbols. The values for the consecutive number of binarization symbols may be obtained using the same probability value.

The device may determine a probability measure based on the first value and the second value and obtain the probability value associated with the third binarization symbol based the probability measure. The probability measure may be determined based on an average of the first value and the second value or a weighted average of the first value and the second value. In some examples, the first value may have been obtained at a first time, the second value may have been obtained at a second time, and a third value for the third binarization symbol may be obtained at a third time that is closer in time to the second time than the first time. The device may determine a weighted average of the first value and the second value by assigning a greater weight to the second value than to the first value and obtain the probability value associated with the third binarization symbol based on the weighted average of the first value and the second value.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 illustrates an example of entropy coding.

FIG. 6 illustrates an example of parameters initialization.

FIG. 7 illustrates an example of decoding a bin.

FIG. 8 illustrates an example probability update 8(a) and an example probability update 8(b).

### DETAILED DESCRIPTION

A more detailed understanding may be had from the following description, given by way of example in conjunction with the accompanying drawings.

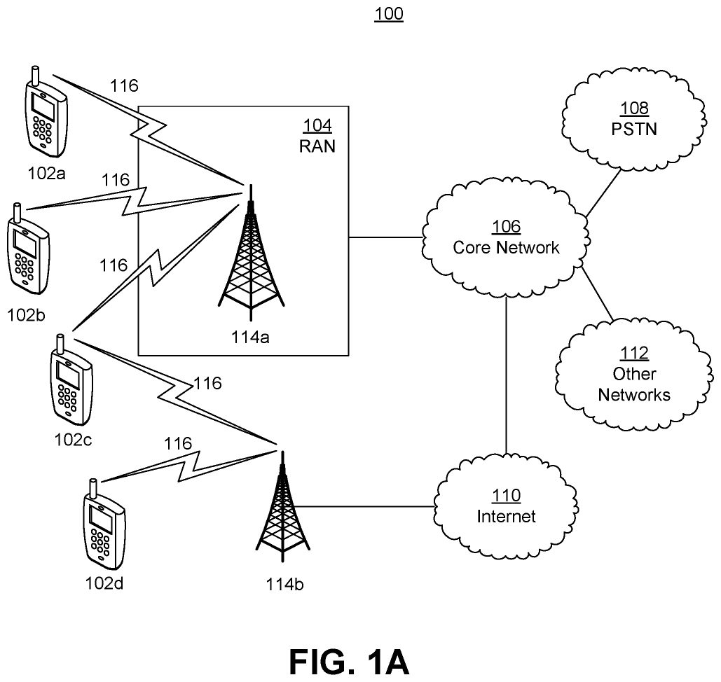

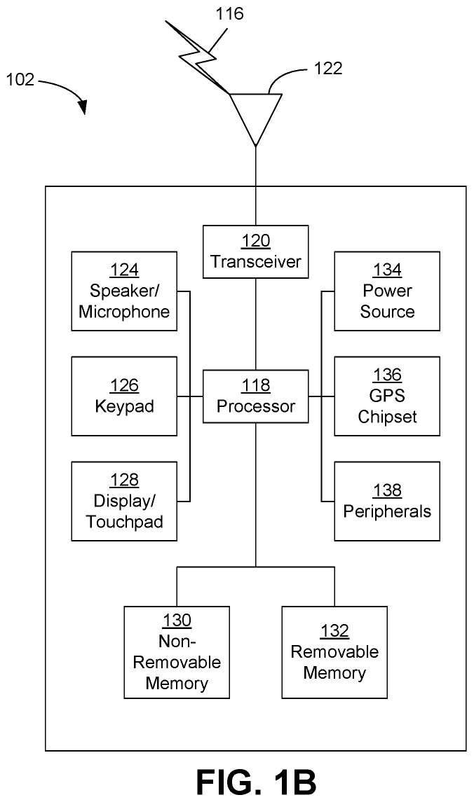

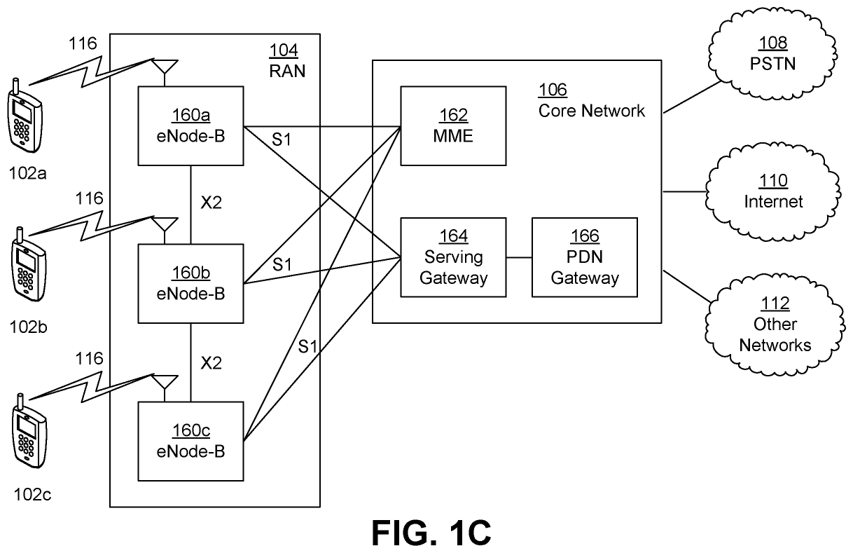

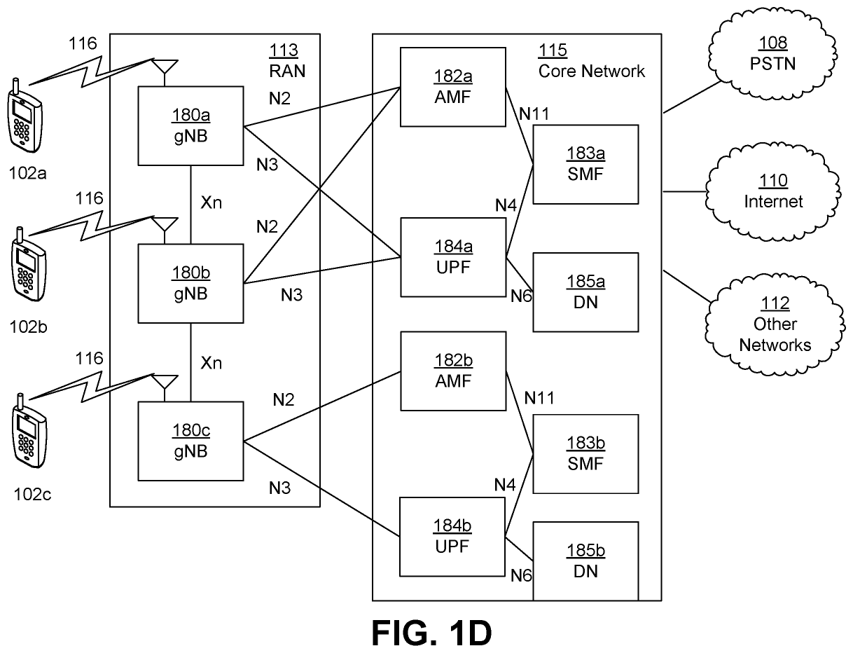

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two noncontiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

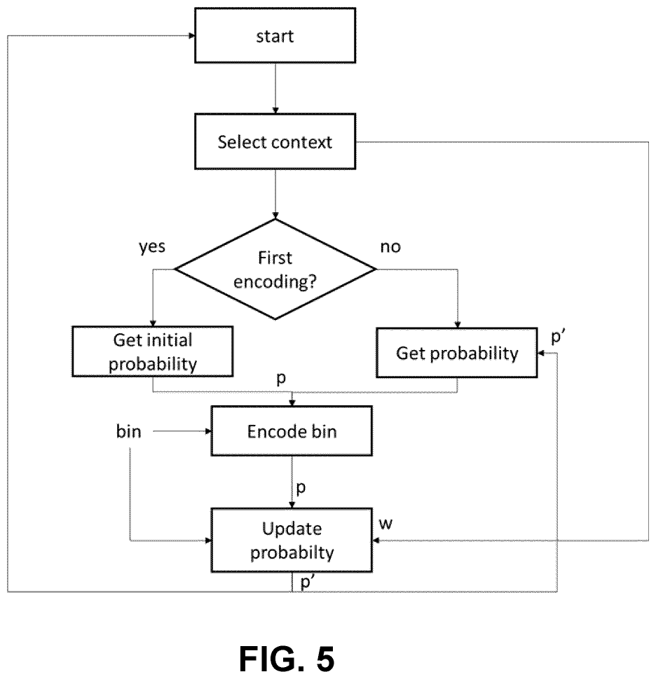

The aspects described and contemplated in this application may be implemented in many different forms. FIGS. 5-7 described herein may provide some examples, but other examples are contemplated. The discussion of FIGS. 5-7 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

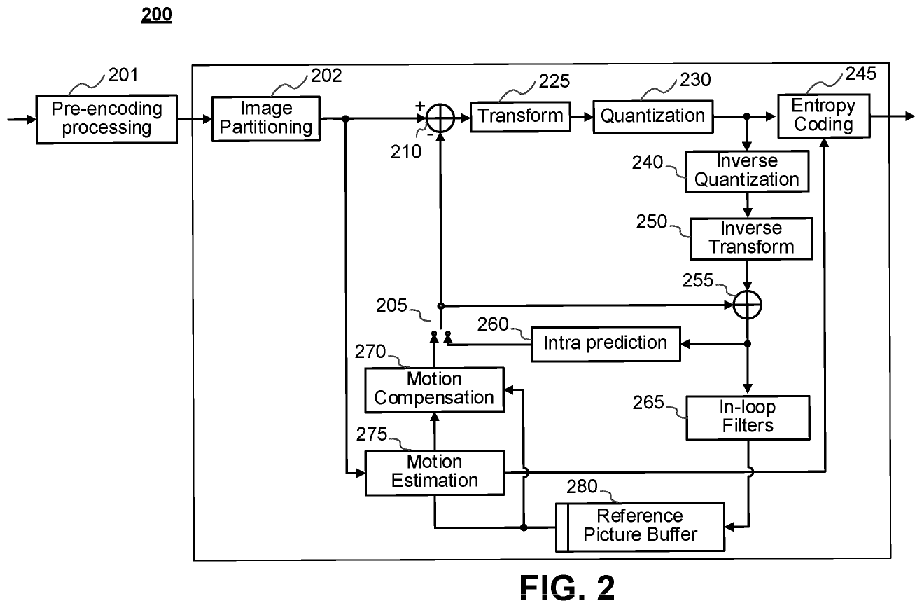

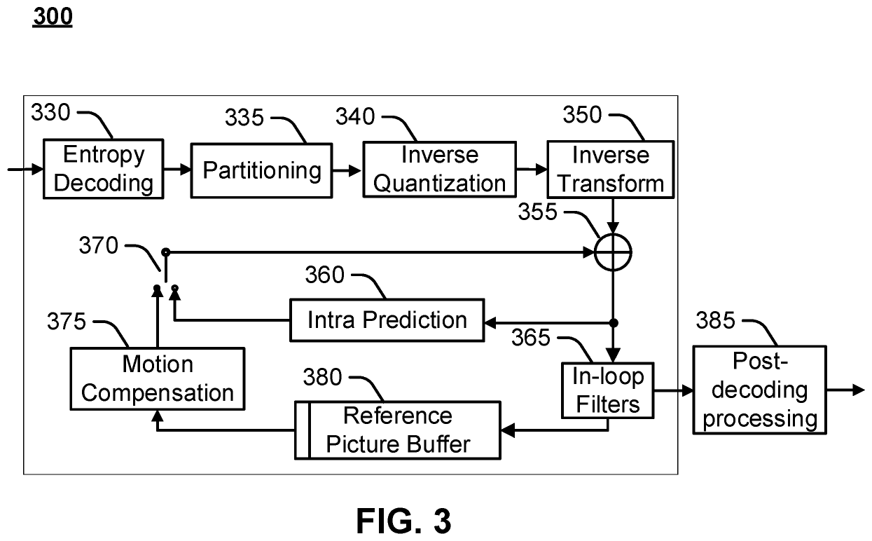

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, for example, 0, 1, 3, 7 etc. These and other specific values are for purposes of describing examples and the aspects described are not necessarily limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals.

Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

An example context adaptive binary arithmetic coder (e.g., encoder and/or decoder) with dynamic model switch and/or parametrization may be used.

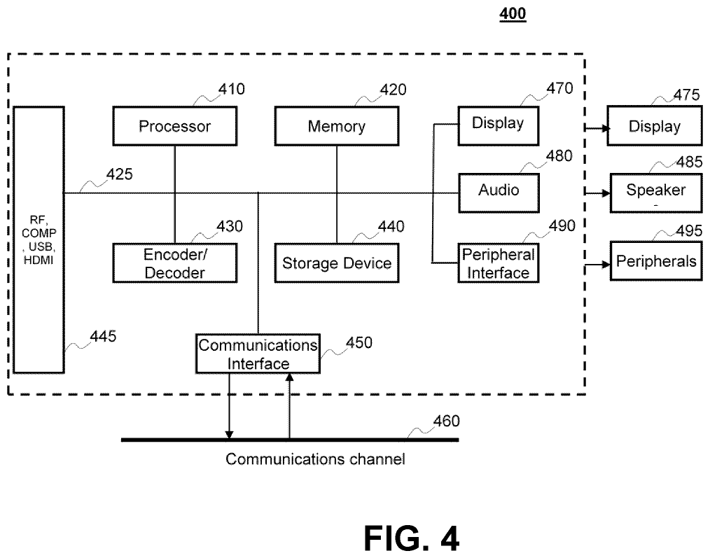

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, determining updated probability values based on a probability measurement value and initial probability values; obtaining a first value for a first binarization symbol associated with video data; obtain a second value for a second binarization symbol associated with the video data; obtaining a probability value associated with a third binarization symbol associated with the video data based on the first value, the second value, and a probability value associated with the first binarization symbol; decoding the video data based on the probability value associated with the third binarization symbol etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining updated probability values based on a probability measurement value and initial probability values; obtaining a first value for a first binarization symbol associated with video data; obtain a second value for a second binarization symbol associated with the video data; obtaining a probability value associated with a third binarization symbol associated with the video data based on the first value, the second value, and a probability value associated with the first binarization symbol; decoding the video data based on the probability value associated with the third binarization symbol etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, a slice header CABAC initialization indication, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, sh_cabac_init_flag, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

In some video codec, a large part of the signaling may be done using an entropy coding of the values to transmit. In the case of using context-adaptive binary arithmetic coding (CABAC), binary values (e.g., only binary values) may be encoded and/or decoded, and generic values may (e.g., first) undergo binarization (e.g., a binarization process). In some examples, to encode or decode a bin (e.g., for each individual bin to encode), a context may be attached and the probability of each bin to encode or decode (e.g., each bin associated with the context) may be updated after each encoding/decoding. The speed at which the probability is updated may be a first parameter of a model (e.g., a context model). A second parameter of the model may be an initial probability used by the model.

Systems, methods, and instrumentalities are disclosed for performing context-adaptive binary arithmetic coding (CABAC) update. The device may be configured to obtain a value of a first probability state and a value of a second probability state associated with context-adaptive entropy coding. The device may be configured to generate a first plurality of entropy encoded values from a plurality of bin values based on the value of the first probability state and the value of the second probability state. The device may be configured to determine a probability measure value based on the first plurality of entropy encoded values. The device may be configured to determine an updated value of the first probability state based on at least the probability measure value and the value of the first probability state.

The device may be configured to determine an updated value of the second probability state based on at least the probability measure value and the value of the second probability state. The device may be configured to generate a second plurality of entropy encoded values based on the updated value of the first probability state and the updated value of the second probability state. Determining the probability measure value based on the first plurality of entropy encoded values may include determining a ratio of an encoded value equal to 1 among the first plurality of entropy encoded values. Determining the probability measure value based on the first plurality of entropy encoded values may include determining a value that appears most frequently among the first plurality of entropy encoded values. Determining the updated value of the first probability state based on at least the probability measure value and the value of the first probability state may include determining the updated value of the first probability state based on the probability measure value, the value of the first probability state, and/or a first window size. Determining the updated value of the second probability state based on at least the probability measure value and the value of the second probability state may include determining the updated value of the second probability state based on the probability measure value, the value of the second probability state, and/or a second window size.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

Systems, methods, and instrumentalities are disclosed for a device configured to obtain a bin value based on a probability value that has been updated based on multiple bin values.

A device (e.g., a decoder) may obtain a first value for a first binarization symbol associated with video data and obtain a second value for a second binarization symbol associated with the video data. The device may obtain a probability value associated with a third binarization symbol associated with the video data based on the first value, the second value, and a probability value associated with the first binarization symbol. The device may then decode the video data based on the probability value associated with the third binarization symbol. In examples, a value of a binarization symbol (e.g., the first value of the first binarization symbol) may be for a syntax element. In some examples, the first, second and third binarization symbols may be for one or more transform coefficients.

In examples, the first, second and third binarization symbols may be associated with a context for entropy decoding. For example, the first, second and third binarization symbols may be associated with an entropy decoding context for decoding the video data using context-based adaptive binary arithmetic coding (CABAC). The probability value associated with the first binarization symbol may be a context probability value associated with the entropy decoding context, and the probability value associated with the third binarization symbol may be an updated context probability value associated with the entropy decoding context. The probability value associated with the first binarization symbol may be used to obtain the first value for the first binarization symbol and the value for the second binarization symbol. The probability value associated with the third binarization symbol may be obtained by updating the probability value associated with the first binarization symbol based on the values for the first and second binarization symbols. The probability value associated with the third binarization symbol may be used to obtain a third value for the third binarization symbol.

In some examples, the device may obtain a predetermined number of values for a first consecutive number of binarization symbols associated with a context for entropy decoding (e.g., the first and the second binarization symbols may be part of the first consecutive number of binarization symbols), entropy decode the first consecutive number of binarization symbols based on a context probability value associated with the context, and entropy decode a second consecutive number of binarization symbols based on an updated context probability value associated with the context. The context probability value may be updated based on the first consecutive number of binarization symbols. The first consecutive number of binarization symbols and the second consecutive number of binarization symbols may not overlap.

The device may obtain a window size associated with the context and obtain the probability value associated with the third binarization symbol further based on the window size. The device may obtain the probability value associated with the third binarization symbol further based on a weighting factor. The weighting factor may be determined using the window size. In some examples, the device may obtain the probability value associated with the third binarization symbol further based on an error that indicates an inconsistency between the obtained second value and the probability value associated with the second binarization symbol.

The second value for the second binarization symbol may be obtained before the probability value associated with the first binarization symbol is updated. For example, the device may refrain from updating the probability value associated with the first binarization symbol until the second value is obtained. The second value for the second binarization symbol may be obtained based on the same probability value associated with the first binarization symbol. The device may continue to obtain a predetermined number of values for a consecutive number of binarization symbols before updating the probability value associated with the first binarization symbol. For example, the device may have obtained a respective value for each of the consecutive number of binarization symbols before updating the probability value associated with the first binarization symbol, and the second binarization symbol is one of the consecutive number of binarization symbols. The values for the consecutive number of binarization symbols may be obtained using the same probability value.

The device may determine a probability measure based on the first value and the second value and obtain the probability value associated with the third binarization symbol based the probability measure. The probability measure may be determined based on an average of the first value and the second value or a weighted average of the first value and the second value. In some examples, the first value may have been obtained at a first time, the second value may have been obtained at a second time, and a third value for the third binarization symbol may be obtained at a third time that is closer in time to the second time than the first time. The device may determine a weighted average of the first value and the second value by assigning a greater weight to the second value than to the first value and obtain the probability value associated with the third binarization symbol based on the weighted average of the first value and the second value.

In examples, a video decoding device may obtain a first probability value associated with context-adaptive entropy coding for a predetermined number of bins in a context; generate a first plurality of entropy decoded values based on the first probability value associated with the context; obtain a second probability value associated with the context based on the first plurality of entropy decoded values and the first probability value associated with the context; and generate a second plurality of entropy decoded values based on the second probability value associated with the context.

As illustrated in FIGS. 2 and 3, a video encoder/decoder (codec) may employ entropy coding (e.g., entropy encoding and/or entropy decoding) techniques to compress or de-compress video data. The video codec may, for example, apply context-based coding, such as context-adaptive binary arithmetic coding (CABAC) techniques to the video data. For example, the video codec may encode/decode binary values and/or generic values that may be obtained through a binarization process and represented by a plurality of binary symbols (bin(s)). The video encoder/decoder may determine a context for (e.g., attach a context to) a bin to be processed and may update a probability state (e.g., a probability value) of the context, for example, after completing an encoding/decoding operation on the bin or more bins. The video encoder/decoder may determine an entropy coding context model (e.g., an entropy encoding context model or an entropy decoding context model) for an entropy coding operation or process (e.g., based on the context of the operation or process), and may perform the entropy coding operation or process based on the context model. A context model may include a plurality of context specific parameters including, for example, an initial probability state associated with the entropy coding operation, and/or a speed at which the probability state may be updated, etc.

FIG. 5 illustrates an example of entropy coding. An entropy coding (e.g., entropy encoding shown at 245 in FIG. 2 or entropy decoding shown at 330 at FIG. 3) may use one or more of a multi-hypothesis probability estimation, a context-adaptive probability update rule, or a multiple-symbol arithmetic coder, for example, to achieve a lossless compression of video data that minimizes resources used to store or transmit the video data. One or more elements in the example in FIG. 5 may be associated with entropy encoding and may be applicable to entropy decoding. Entropy coding may include binarization of video data, for example, when CABAC is used for the entropy coding of the video data. The binarization may provide one or more bins. A bin may include one or more binarization symbols. In examples, a bin may include binarized information of a syntax element. A bin may include binarized information of a transform coefficient (e.g., a quantized transform coefficient).

One or more bins related to entropy coding of video data may be associated with a context model, for example, when CABAC is used for the entropy coding of the video data. In one or more examples herein, the term “context” and the term “context model” may be used interchangeably. As shown in FIG. 5, a context may be selected for a bin (e.g., each bin). A context (e.g., each context) may include one or more of context variables such as window size(s) or probability value(s) (e.g., an initial probability value and/or current probability value(s) which may, in some examples, have been updated based on a previous probability value(s)). A context may include one or more current probability values. For example, multiple (e.g., two) probabilities may be maintained, such as probability state p0 and probability state p1. In some examples, a current probability value may be determined based on the probability state p0 and the probability state p1. As shown in FIG. 5, a determination is made on whether the current encoding is the first encoding (e.g., whether the current bin is the first one to encode). If the current encoding is the first encoding, the initial probability value may be obtained. If the current encoding is not the first encoding, the current probability value may be obtained. A bin may be encoded using the initial probability value or the current probability value depending on determination of whether the current encoding is the first encoding. The encoded bin may be used to update the initial probability value or the current probability value. A context may include windows size(s), which may indicate or correspond to an update speed of a probability state (e.g., the probability state associated with the context). The window size(s) may be used to update the initial probability value or the current probability value. The updated probability value may then become the probability value to be used for encoding the next bin or a number of subsequent bins. In one or more examples herein, the term “probability,” the term “probability state,” and the term “probability value” may be used interchangeably to indicate a likelihood of a certain value (e.g., a bin value). The likelihood of the certain value may be associated with a bin, associated with multiple bins associated with a context, or associated with a context. A probability value and/or window size may be context variable(s) associated with a context. A probability value may be updated, e.g., as shown in equation 3-46.

$${p}^{′} = w * q + ( 1 - w ) * p \qquad ( 3 - 46 )$$

In equation 3-46, p may represent a previous probability (e.g., a previous probability value associated with a context (a context probability value)), p′ may represent an updated probability (e.g., an updated probability value associated with the context (updated context probability value), b may indicate a current bin encoded/decoded (e.g., a bin that has been obtained by encoding or decoding), and w may be associated with a window size (e.g., w may represent the window size associated with the selected context model). Multiple probability states (e.g., p0 and p1) may be updated based on respective window sizes (e.g., w0 and w1).

A window size (e.g., w0 or w1) may indicate a speed (e.g., a logarithmic speed) of an update, for example, as shown in equation 2-46.

$$w = 2 \hat{} ( - ws ) \qquad ( 2 - 46 )$$

In equation 2-46, ws represents a window size. A weighting factor may be determined based on a window size. The weighting factor may be used to determine an updated probability value. As shown in equation 2-46 and equation 3-46, a smaller window size may indicate a faster (e.g., less stable) update, and a bigger window size may indicate a slower (e.g., stabler) update. For example, a first probability state p0 and/or a second probability state p1 may be updated at different speed by using different window sizes w0 and w1. The first probability state p0 and/or the second probability state p1 may indicate a probability of a bin value being one, for example,

A bin (e.g., each bin) may be encoded/decoded based on the multiple probability states. For example, the bin may be encoded/decoded based on the mean of the multiple probability states (e.g., a simple mean of the two probabilities p0 and p1). One or more of the multiple probability states (e.g., p0 and p1) may be initialized using a same initial probability value. A context may include initial probability value(s). In examples, the initial probability value associated with the context may be used to initialize one or more of the multiple probability states (e.g., p0 and/or p1).

The parameters for a given context (e.g., an initial probability, windows size(s) may be determined based on (e.g., may depend on) one or more parameters associated with video data (e.g., one or more parameters external to the context). For example, for a (e.g., every) context there may be a specific rule (e.g., an LUT or linear) which allows a decoder or encoder to derive CABAC parameters based on the external parameters (e.g., slice type and qp).

For example, the one or more parameters used to determine the parameters for a context may include the type of a slice to encode or decode, such as a type of intra slice (I-slice), a type of bi-prediction slice (B), or a type of uni-direction slice (P). The one or more parameters used to determine the parameters for a context may include a quantization parameter (qp) (e.g., the qp associated with a slice, the qp associated with a block, etc.).

In some examples, a context model may be selected by an encoder and indicated to a decoder, and the parameters associated with the context model may be used by the encoder and the decoder. For example, the association of the parameters with the context model may be predetermined (e.g., hardcoded). A context model (e.g., each context model) may use the associated parameters (e.g., use fixed parameters for the context) between the encoder and the decoder. These parameters may be decided per context.

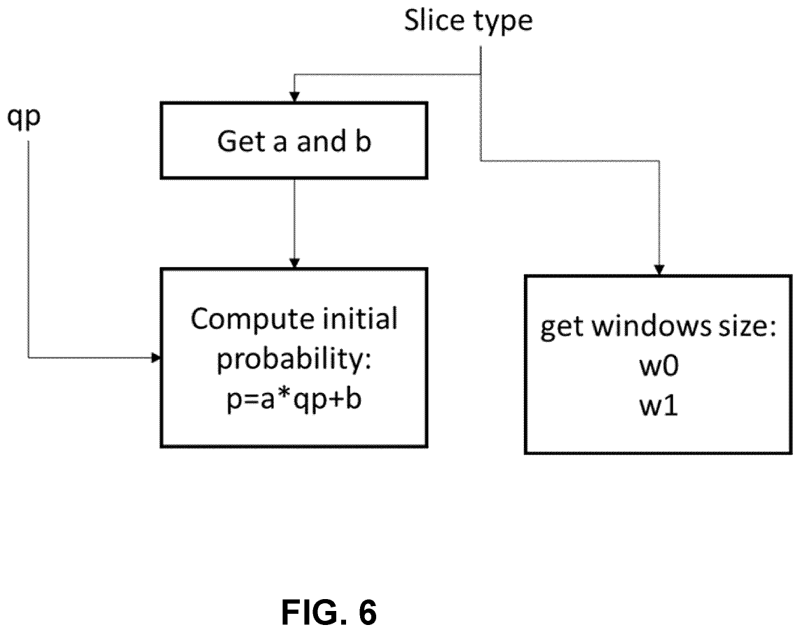

One or more parameters associated with a context module may be initialized for slice, for example, before the slice is entropy decoded. For example, at the beginning of a slice (e.g., each slice), the parameters may be initialized as depicted in FIG. 6. FIG. 6 illustrates an example of parameter initialization. The one or more parameters associated with a context module may include an initial probability value associated with the context model and/or window size(s).

As shown in FIG. 6, the parameter initialization may be based on one or more of a slice type and/or a quantization parameter qp. A slope coefficient a and an offset b may be obtained, for example, based on the slice type. An initial probability value associated with the context model may be determined based on the quantization parameter qp, the slope coefficient a, and the offset b, e.g., using a linear function p=a*qp+b. A first window size w0 associated with the context model and/or a second window size w1 associated with the context model may be obtained, for example, based on the slice type.

Switching of initialization parameters may be allowed. An indication (e.g., a flag represented by sh_cabac_init_flag) may be signaled (e.g., by an encoder) or obtained (e.g., by a decoder) in a slice header (e.g., for a non-intra slice) to indicate whether initialization parameter switching may be allowed for the slice. For example, if sh_cabac_init_flag in the slice header is set to true for a B slice, initialization parameters configured for P slices may be used for the B slice. If sh_cabac_init_flag is set to false for the B slice, P slice parameters set may not be used for the B slice.

Table 1 below illustrates signaling syntax associated with a sh_cabac_init_flag.

| | |
|---|---|
| if( sh_slice_type != I ) { | |
| if( pps_cabac_init_present_flag ) | |
| sh_cabac_init_flag | u(1) |

A context-based coding (e.g., CABAC) may use one or more of the following: a core CABAC engine, separate residual coding structures for transform blocks and transform skip blocks, and context modeling transform coefficients.

A CABAC engine (e.g., the core CABAC engine or a CABAC engine different from the core CABAC engine) may use a table-based probability transition process between 64 different representative probability states. The range ivlCurrRange representing the state of the coding engine may be quantized to a set of 4 values prior to a calculation of an interval range (e.g., a new interval range). The state transition may be implemented using a table containing the 64×4 8-bit pre-computed values to approximate the values of ivlCurrRange*pLPS(pStateIdx), where pLPS may be the probability of the least probable symbol (LPS) and pStateIdx may be the index of a state (e.g., a current probability state). A decode decision may be implemented using a pre-computed LUT. ivILpsRange may be obtained using the LUT as described in 3-47. ivILpsRange may be used to update ivlCurrRange and to calculate the output binVal.

$$ivILpsRange = rangeTabLps [ pStateIdx ] [ qRangeIdx ] \qquad ( 3 - 47 )$$

In some examples, the probability may be (e.g., linearly) expressed by a probability index pStateIdx. Calculation(s) may be performed using equations (e.g., without an LUT operation). A multi-hypothesis probability update model may be applied (e.g., to improve the accuracy of the probability estimation). The pStateIdx (e.g., the pStateIdx used in the interval subdivision in the binary arithmetic coder) may be a combination of multiple probabilities (e.g., two probabilities, such as pStateIdx0 and pStateIdx1). A (e.g., each) context model may be associated with multiple probabilities (e.g., two probabilities, such as pStateIdx0 and pStateIdx1). The multiple probabilities associated with the context model (e.g., each context model) may be updated independently (e.g., independently with different adaptation rates). The adaptation rates of pStateIdx0 and pStateIdx1 for a context model (e.g., each context model) may be pre-trained, e.g., based on the statistics of the associated bins. The probability estimate pStateIdx may be an average of the estimates from the two hypotheses (e.g., pStateIdx0 and pStateIdx1).

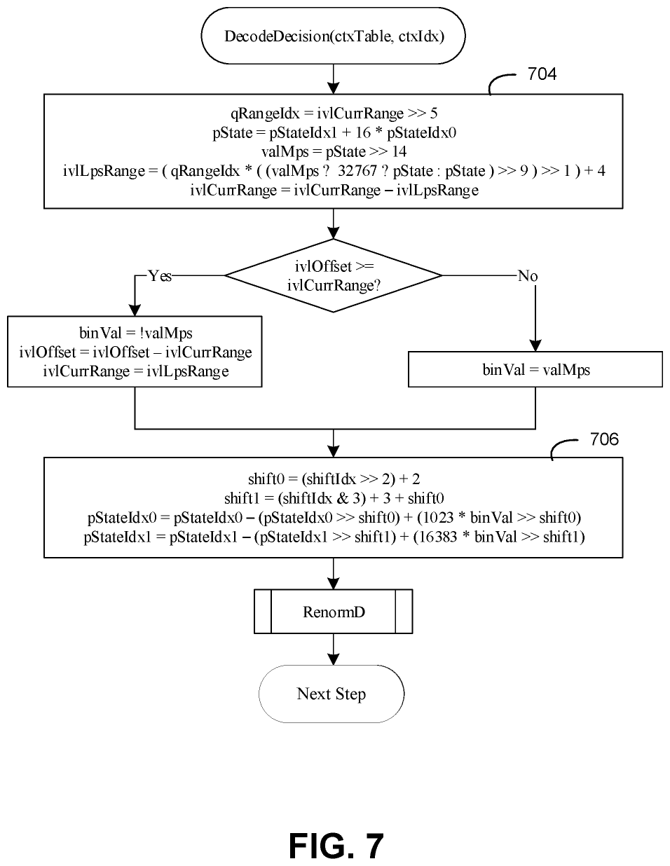

FIG. 7 illustrates an example of decoding a bin, such as decoding a single binary decision in a codec (e.g., the first codec). As shown in FIG. 7, at 704, the parameters for decoding may be determined. The probability value pState which has been used by the encoder may be computed from the two probability states pStateIdx1 and pStateIdx2. The current binary element binVal may be decoded. At 706, pStateIdx1 and pStateIdx2 may be updated depending on the decoded binary value binVal.

Entropy coding (e.g., entropy decoding or encoding) may use context-based coding. In examples, CABAC may include a parameter initialization process (e.g., a quantization parameter-dependent initialization process) that may be invoked, for example, at the beginning of a slice (e.g., before processing of the slice is started). For example, given an initial value of luma qp for the slice, the initial probability state of a context model (e.g., denoted as preCtxState) may be derived using one or more of equations 3-48, 3-49, and 3-50.

$$m = slopeIdx \times 5 - 45 \qquad ( 3 - 48 )$$

$$n = ( offsetIdx << 3 ) + 7 \qquad ( 3 - 49 )$$

$$preCtxState = Clip 3 ( 1 , 127 , ( ( m \times ( QP - 32 ) ) >> 4 ) + n ) \qquad ( 3 - 50 )$$

Herein, a slope coefficient slopeIdx and an offset offsetIdx may be restricted to 3 bits, and the initialization values (e.g., the total initialization values) may be represented by 6-bit precision.

In some examples, the initial probability state of a context model (e.g., denoted as preCtxState) may be derived using one or more of equations 4-48, 4-49, and 4-50.

$$m = ( initId >> 3 ) - 4 \qquad ( 4 - 48 )$$

$$n = ( ( initId \& 7 ) * 18 ) + 1 \qquad ( 4 - 49 )$$

$$preCtxState = Clip 3 ( 1 , 127 , ( ( m * ( qp - 16 ) ) >> 1 ) + n ) \qquad ( 4 - 50 )$$

Herein, initId may be a parameter that depends on the slice type and/or the CABAC context.

The probability state preCtxState may represent a probability in the linear domain (e.g., directly). The probability state preCtxState may be determined using one or more shifting operations (e.g., only using proper shifting operation(s)) before the probability state preCtxState is used as an input to an arithmetic coding engine (e.g., shown as follows in equations 3-51 and 3-52), and logarithmic to linear domain mapping(s) and/or a 256-byte table may be saved. A shifting operation may correspond to a window size in one or more examples herein. For example, pStateIdx0 in equation 3-51 may correspond to the probability state p0 in one or more examples herein. pStateIdx1 in equation 3-51 may correspond to the probability state p1 in one or more examples herein. The shifting operations preCtxState<<3 of equation 3-51 may correspond to the window size w0 in one or more examples herein, and the shifting operations preCtxState<<7 of equation 3-52 may correspond to the window size w1 in one or more examples herein. The window size w0 corresponding to the shifting operations preCtxState<<3 of equation 3-51 and the window size w1 corresponding to the shifting operations preCtxState<<7 of equation 3-52 may be different, indicating that the probability state p0 and the probability state p1 may be updated at different rates.

$$pStateIdx 0 = preCtxState << 3 \qquad ( 3 - 51 )$$

$$pStateIdx 1 = preCtxState << 7 \qquad ( 3 - 52 )$$

Extended precision(s) may be implemented in entropy coding. The intermediate precision used in an arithmetic coding engine may be increased. For example, the precisions for two probability states may be increased to 15 bits (e.g., in comparison to 10 bits and 14 bits in a certain codec). The least probably symbol (LPS) range update process may be performed using the example shown in 3-53.

$$if q >= 16384 \qquad ( 3 - 53 )$$

$$q = {2}^{15} - 1 - q$$

$${R}_{LPS} = ( ( range * ( q >> 6 ) ) >> 9 ) + 1 ,$$

Range in 3-53 may be a variable (e.g., a 9-bit variable) representing the width of the current interval; q may be a variable (e.g., 15-bit variable) representing the probability state of the current context model; and R_{LPS} may be the updated range for LPS. This operation may be realized by looking up a 512×256-entry in 9-bit look-up table. The 256-entry look-up table used for bits estimation may be extended to 512 entries, for example, at the encoder side.

A window size may be adapted to a slice type. Statistics may be different with different slice types. A context probability state may be updated at a rate that is determined based on a slice type (e.g., at a rate that is optimal for a given slice type). For a context model (e.g., each context model), multiple (e.g., three) window sizes may be used (e.g., pre-defined window sizes for I-, B-, and P-slices, respectively) for example, according to FIG. 6. The context initialization parameters and/or window sizes may vary for a respective context model. In some examples, the context initialization parameters and/or window sizes may be retrained when a context model changes.

The CABAC update mechanism may be implemented, for example, to include further refinements. In examples, an encoder may have a certain number of values (e.g., residual coefficients, flags etc.) to transmit. These values may be binarized, for example, so that binary symbols (e.g., only binary symbols) may be considered. For a (e.g., each) binary symbol, a CABAC context may be determined. For example, a specific flag may be associated with context #45, and/or the first bin of the binarization of each residual coefficient may belong to context #37. A (e.g., each) context may maintain a probability value, which may be employed to entropy compress binary symbol(s). Data generated, as described herein, may be sent to a decoder, which may deduce the CABAC context and the probability value of the CABAC context. The decoder may decompress the data and recover the binary symbol(s). As shown in one or more examples herein, the probability value of the CABAC context may be obtained based on values of two probability states (e.g., as a simple or weighted average of p0 and p1). The two probability states may be initialized at the beginning of a (e.g., each) slice, and updated after one or more observed bin values. In examples, the update may be based on the current probability value of the CABAC context, one or more decoded/encoded bin values, and a window size. A window size is a parameter specific to the CABAC context. Two different window sizes may be used for the updates of the two different probability states (e.g., p0 and p1). The values of the two different probability states may be stored (e.g., independently within the CABAC context). In examples, the two different probability states may be updated using the same rule (e.g., according to equation 2-46 or equation 3-54) and/or different window sizes.

A probability value associated with a context model for entropy decoding of video data may be obtained based on multiple bin values associated with the entropy decoding of the video data, for example, by updating the current probability value (e.g., an initial probability value, a subsequent, updated probability value) based on multiple bin values associated with the context.

The state(s) (e.g., probability value(s) associated with a context model) may be updated in a noncontiguous manner (e.g., the update does not occur after each bin value has been decoded). The state(s) may be updated after multiple bins have been decoded (e.g., instead of being updated after every bin has been decoded). In examples, an CABAC update mechanism (e.g., an update of a context model where the current probability value associated with the context model is updated) may be periodical, for example, occur after every T number of bins have been decoded.

An update of the current probability value associated with the context model (e.g., a context probability state update) may occur after multiple bin values have been decoded or encoded. In examples, a first value of a first binarization symbol may be obtained (e.g., encoded or decoded). A second value of a second binarization symbol may be obtained based on the same probability value as the one used for the first binarization symbol (e.g., instead of updating the current probability value associated with the context model based on the decoded first value of the first binarization symbol). A binarization symbol may have a value of zero or one. The current probability value associated with the context model may be updated based on the values of the first and the second binarization symbols. The update of the current probability value associated with the context model may not occur after each value of a respective bin is decoded or encoded. The update of the current probability value associated with the context model may not occur before at least one more bin value has been decoded or encoded. In examples, a decoder or an encoder may refrain from updating the current probability value associated with the context model until the second value of the second binarization symbol has been obtained.

A bin (e.g., a binarization unit) may include one or more binarization symbols. For example, a bin may include binarized information for a syntax element. A bin may include binarized information for one or more transform coefficients. In some examples, a bin may include a binarization symbol to be decoded or encoded (e.g., a binary flag, or one of the results of binarization of another syntax element).

In examples, the state(s) (e.g., probability value(s) associated with a context model) may be updated periodically, for example, after every T number of bins have been decoded. In examples, a decoder may obtain a T number of values for a first consecutive number of binarization symbols based on a first context probability value associated with the context model, for example, using entropy decoding. The decoder may obtain the second context probability value associated with the context model based on the obtained T number of values for the first consecutive number of binarization symbols. The decoder may obtain another T number of values for a second consecutive number of binarization symbols based on the second context probability value associated with the context model.

The T number of bins may be predetermined or adaptive (e.g., adapted based on a qp or a slice type, as shown in FIG. 6). For example, if the T number of bins is adaptive, the number T may be adapted to a context model (e.g., a CABAC context model). In some examples, one or more parameters including the number T, the initial probability value of a context model, and window size(s) associated with the context model may be adapted, based on one or more of a context model (e.g., a hard-coded CABAC context model), a slice type, or a qp.

An updated probability value (e.g., an updated probability associated with a context model) may be obtained based on multiple decoded bin values (e.g., T number of decoded bin values), for example, as shown in equation (3-54). Given a period, for example a period having T coefficients, the update formula may be used, e.g., shown in equation (3-54).

$${p}^{′} = w * q + ( 1 - w ) * p \qquad ( 3 - 54 )$$

For example, as shown in equation (3-54), p may indicate the current probability, p′ may indicate the updated probability, and q may indicate a probability measure. The probability measure may be derived from T coefficients (e.g., the previous T coefficients). A device may obtain a probability measure based on multiple bin values (e.g., T number of decoded bin values). For example, the device may obtain a first value (e.g., a first decoded value, a first encoded value, or a first observed value) for a first binarization symbol associated with video data, the device may obtain a second value (e.g., the device may continue to decode, continue to encode, or continue to observe the second value) for a second binarization symbol associated with the video data. The device may obtain a probability value (e.g., an updated probability value p′ such as an update of p0, an update of p1, or an update of a mean of p0 and p1) associated with a third binarization symbol associated with the video data based on the first value (e.g., one of the T decoded bin values used to obtain the probability measure), the second value (e.g., another one of the T decoded bin values used to obtain the probability measure), and a probability value (e.g., the probability value p before the update, such as p0, p1, or a mean of p0 and p1) associated with the first binarization symbol.

A context model may be associated with an initial probability value, and the probability value associated with the first binarization symbol may be the initial probability value of the context model.

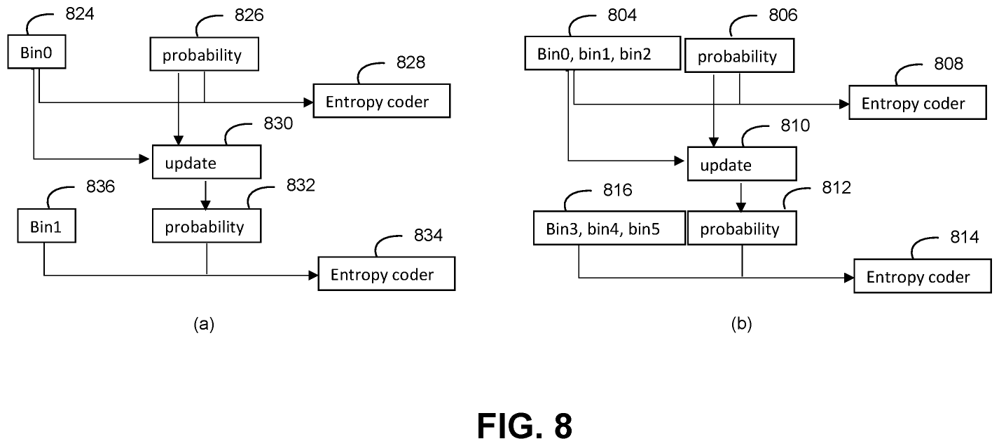

FIG. 8 shows an example probability update 8(a) and an example probability update 8(b).

As shown in example (a), a value of a bin0 of 824 may be obtained using a probability 826 (e.g., the probability value p in equation 3-46) by an entropy coder 828 (e.g., the entropy coder 828 may be an entropy decoder or an entropy encoder). In examples, the bin0 may be associated with a context model (e.g., as characterized by one or more context variables or indicated by a context model index). The probability 826 may include a first probability value associated with the context model. At 830, the probability 826 may be updated to obtain an updated probability 832, for example, using equation 3-46. The updated probability 832 may be, for example, the probability value p′ in equation 3-46. The updated probability 832 may be obtained based on the probability 826 and the obtained value of the bin0, for example, according to equation 3-46 or equation 3-54 when the probability measure of equation 3-54 is determined based on a bin value. A value of a bin1 of 836 may be obtained using the updated probability 832 (e.g., the updated probability value p′ in equation 3-46) by an entropy coder 834 (e.g., the entropy coder 834 may be an entropy decoder or an entropy encoder). In examples, the bin1 may be associated with the same context model as the context model associated with the bin0. The probability 832 may include a second probability value associated with the context model. In some examples, the probability 826 may be an initial probability value associated with the context model.

As shown in example 8 (b), a value of a bin0, a value of a bin1, and a value of a bin2 of 804 may be obtained using a probability 806 (e.g., the probability value p in equation 3-54) by an entropy coder 808 (e.g., the entropy coder 808 may be an entropy decoder or an entropy encoder). In examples, the bin0, the bin1, and the bin2 may be associated with a context model (e.g., as characterized by one or more context variables or indicated by a context model index). The probability 806 may include a first probability value associated with the context model. At 810, the probability 806 may be updated to obtain an updated probability 812, for example, using equation 3-54. The updated probability 812 may be, for example, the probability value p′ in equation 3-54. The updated probability 812 may be obtained based on the probability 806, the obtained value of the bin0, the obtained value of the bin1, and the obtained value of the bin2, for example, according to equation 3-54 when the probability measure of equation 3-54 is determined based on three bin values. A value of a bin3, a value of a bin4, and a value of a bin5 of 816 may be obtained using updated probability 812 (e.g., the updated probability value p′ in equation 3-54) by an entropy coder 814 (e.g., the entropy coder 814 may be an entropy decoder or an entropy encoder). In examples, the bin3, the bin4, and the bin5 may be associated with the same context model as the context model associated with the bin0, the bin1, and the bin2. The probability 812 may include a second probability value associated with the context model. In some examples, the probability 806 may be an initial probability value associated with the context model.

An updated probability value may be obtained based on information determined from multiple decoded bin values (e.g., T number of decoded bin values). The probability measure in equation 3-54 may include the information determined from the multiple decoded bin values.

In examples, the information determined from multiple decoded bin values may indicate a frequency at which a certain value is obtained for the previous T bins. For example, the probability measure q may be the ratio of bins equal to 1 in the previous T bins. For example, if the value of bin0 is 1, the value of bin1 is 0, and value of bin 2 is 1 in the example 8 (b) in FIG. 8, the probability measure q for the example 8 (b) may be determined to be 2/3.

A context model may be associated with a window size. As shown in equation 3-54, a weighting factor associated with the window size may be used to determine the updated probability value. As shown in equation 3-54, the probability measure q may be weighted using a weighting factor w. The weighting factor w may be associated with a window size (e.g., an updated window size). A window size (e.g., the updated window size) and the weighting factor may vary (e.g., be retrained) for a respective context model (e.g., for each CABAC context). The window size may be derived from currently used windows (e.g., in such a way that the weight assigned to the current probability value p is approximately the same as the weight that CABAC may assign to the probability T steps in the past). For example, the window size be used to determine the weighting factor w, for example, according to equation 2-46. In some examples, the probability measure q may be a mode value of the previous T bins, which may indicate the bin that appears most frequently during the period. For example, the mode value of the previous T bins may be one if more bins equal to 1 have been encoded, decoded, or observed than bins equal to 0. The mode value of the previous T bins may be zero if more bins equal to 0 have been encoded, decoded, or observed than bins equal to 1. In the case that the mode value is not unique, the window size (e.g., the weighting factor w associated with the update window) may be set as 0.

The information determined from multiple decoded bin values may be obtained based on an average or a weighted average of multiple decoded bin values (e.g., T number of decoded bin values). For example, the probability measure q may be a mean or a weighted mean of previous coefficients or of the probability values associated with the previous coefficients. For example, the more recent coefficients may be associated with a greater weight compared to earlier coefficients. In example shown in FIG. 8(b), the value of bin 0 may be obtained at a first time. The value of bin 1 may be obtained at a second time. The value of bin 2 may be obtained at a third time. The third time may be closer in time to a time when a value of bin 4 is to be obtained than the second time or the first time. A weighted average of the value of the bin 0, the value of bin 1, and the value of bin 2 may be obtained by assigning a greater weight to the value of bin 2 than to the value of bin 1 or the value of bin 0. An updated probability value may be obtained based on the weighted average of the value of the bin 0, the value of bin 1, and the value of bin 2.

In some examples, a weighted average of the value of the bin 0, the value of bin 1, and the value of bin 2 may be obtained by assigning a same weight to the value of bin 0, the value of bin 1, and the value of bin 2. In other examples, an average of the value of the bin 0, the value of bin 1, and the value of bin 2 may be obtained without applying weighting factors, and an updated probability value may be obtained based on the average of the value of the bin 0, the value of bin 1, and the value of bin 2.

Auto-regressive moving average (ARMA) models may be used. CABAC models (which may be an instance of exponential smoothing) may be updated to more refined statistical models (e.g., statistical models for time series).

An updated probability value may be obtained based on an error that indicates an inconsistency between an obtained value for a bin and a probability value associated with bin. A probability associated with a context model (e.g., probability model(s) may be updated by taking into account past observed bins and/or past errors, for example, as shown in equation 3-55.

$$e = b - p \qquad ( 3 - 55 )$$

As shown in equation 3-55, b may represent an observed bin value, and p may represent a model state (e.g., a non-quantized model state). An observed bin value may include an encoded bin value or a decoded bin value. In examples, p may be consistent with p in equation 3-54. The error of the previous state associated with a model (e.g., a context model) may be multiplied by a coefficient (e.g., the coefficient in equation 3-56) and may be added to the present probability state associated with the model. This kind of statistical model for the forecast of time series may be an ARMA model. In examples, the coefficient may be hard-coded and/or context-dependent (e.g., identifiable in an LUT).

In examples, an error e_n at bin b_n may be used to correct the probability state (e.g., the CABAC probability state), for example, as shown in equation 3-56.

$$p\_ ( n + 1 ) = w * b\_n + ( 1 - w ) * p\_n + a * e\_n \qquad ( 3 - 56 )$$

In equation 3-56, parameter a may be a parameter (e.g., an offline-learned parameter or coefficient) depending on the slice type and/or on a context model (e.g., a CABAC context). The parameter a may be learned offline. In examples, equation 3-56 may be determined based on equation 3-46 and the error item that is derived based on the coefficient and the error of the previous state associated with the model.

In some examples, several of the previous errors may be used to correct the probability state, for example, as shown in equation 3-57.

$$p\_ ( n + 1 ) = w * b\_n + ( 1 - w ) * p\_n + a\_ 0 * e\_n + a\_ 1 * e\_ ( n - 1 ) + … + a\_k * e\_ ( n - k ) \qquad ( 3 - 57 )$$

In examples, a running estimate of the error may be updated via exponential smoothing, for example, as shown in equation 3-58.

$$q\_n = b * e\_ ( n - 1 ) + ( 1 - b ) * q\_ ( n - 1 ) \qquad ( 3 - 58 )$$

Herein, parameter b may be a parameter (e.g., an offline-learned parameter) depending on the slice type and/or on a context model (e.g., the CABAC context). In examples, parameter b may be hard-coded and/or context dependent (e.g., identifiable in an LUT). The estimate q_n may be (e.g., then) used to correct a probability state (e.g., a CABAC estimate), for example, as shown in equation 3-59.

$$p\_ ( n + 1 ) = w * b\_n + ( 1 - w ) * p\_n + a * q\_n \qquad ( 3 - 59 )$$

In some examples, ARMA models may be used (e.g., conceived) to process time series with continuous values. In some examples, a variant for time series with discrete values may be employed, which may be called new discrete autoregressive moving-average (NDARMA) models. Continuous ARMA models may aim at forecasting future values. Discrete ARMA models may forecast a probability distribution on possible symbols.

In some examples, an indication (e.g., a flag) may be coded to indicate a context model (e.g., a type of CABAC model used), such as the CABAC model described herein. This indication may be signaled in a slice header or a picture header.

Decoding tools and techniques (e.g., as illustrated in FIG. 3) including, for example, one or more of entropy decoding, inverse quantization, inverse transformation, and differential decoding may be used to enable one or more examples as described herein in a decoder. For example, these decoding tools and techniques may be used to enable one or more of obtaining a bin value based on a probability value that has been updated based on multiple bin values; obtaining a first value for a first binarization symbol associated with video data and obtaining a second value for a second binarization symbol associated with the video data; obtaining a probability value associated with a third binarization symbol associated with the video data based on the first value, the second value, and a probability value associated with the first binarization symbol; decoding the video data based on the probability value associated with the third binarization symbol; obtain a predetermined number of values for a first consecutive number of binarization symbols associated with a context for entropy decoding; entropy decoding the first consecutive number of binarization symbols based on a context probability value associated with the context; entropy decoding a second consecutive number of binarization symbols based on an updated context probability value associated with the context; updating the context probability value based on the first consecutive number of binarization symbols; obtaining a window size associated with the context; obtaining the probability value associated with the third binarization symbol further based on the window size; obtaining the probability value associated with the third binarization symbol based on a weighting factor; determining the weighting factor using the window size; obtaining the probability value associated with the third binarization symbol based on an error that indicates an inconsistency between the obtained second value and the probability value associated with the second binarization symbol; obtaining the second value for the second binarization symbol before the probability value associated with the first binarization symbol is updated; refraining from updating the probability value associated with the first binarization symbol until the second value is obtained; obtaining the second value for the second binarization symbol based on the same probability value associated with the first binarization symbol; continuing to obtain a predetermined number of values for a consecutive number of binarization symbols before updating the probability value associated with the first binarization symbol; obtaining a respective value for each of the consecutive number of binarization symbols before updating the probability value associated with the first binarization symbol; obtaining the values for the consecutive number of binarization symbols using the same probability value; determining a probability measure based on the first value and the second value and obtaining the probability value associated with the third binarization symbol based the probability measure; determining the probability measure based on an average of the first value and the second value or a weighted average of the first value and the second value; determining a weighted average of the first value and the second value by assigning a greater weight to the second value than to the first value and obtaining the probability value associated with the third binarization symbol based on the weighted average of the first value and the second value.

Encoding tools and techniques (e.g., as illustrated in FIG. 2) including one or more of quantization, entropy coding, inverse quantization, inverse transformation, and differential coding may be used to enable one or more examples as described herein in the encoder. For example, these encoding tools and techniques may be used to enable one or more of: obtaining a bin value based on a probability value that has been updated based on multiple bin values; obtaining a first value for a first binarization symbol associated with video data and obtaining a second value for a second binarization symbol associated with the video data; obtaining a probability value associated with a third binarization symbol associated with the video data based on the first value, the second value, and a probability value associated with the first binarization symbol; encoding the video data based on the probability value associated with the third binarization symbol; obtain a predetermined number of values for a first consecutive number of binarization symbols associated with a context for entropy encoding; entropy encoding the first consecutive number of binarization symbols based on a context probability value associated with the context; entropy encoding a second consecutive number of binarization symbols based on an updated context probability value associated with the context; updating the context probability value based on the first consecutive number of binarization symbols; obtaining a window size associated with the context; obtaining the probability value associated with the third binarization symbol further based on the window size; obtaining the probability value associated with the third binarization symbol based on a weighting factor; determining the weighting factor using the window size; obtaining the probability value associated with the third binarization symbol based on an error that indicates an inconsistency between the obtained second value and the probability value associated with the second binarization symbol; obtaining the second value for the second binarization symbol before the probability value associated with the first binarization symbol is updated; refraining from updating the probability value associated with the first binarization symbol until the second value is obtained; obtaining the second value for the second binarization symbol based on the same probability value associated with the first binarization symbol; continuing to obtain a predetermined number of values for a consecutive number of binarization symbols before updating the probability value associated with the first binarization symbol; obtaining a respective value for each of the consecutive number of binarization symbols before updating the probability value associated with the first binarization symbol; obtaining the values for the consecutive number of binarization symbols using the same probability value; determining a probability measure based on the first value and the second value and obtaining the probability value associated with the third binarization symbol based the probability measure; determining the probability measure based on an average of the first value and the second value or a weighted average of the first value and the second value; determining a weighted average of the first value and the second value by assigning a greater weight to the second value than to the first value and obtaining the probability value associated with the third binarization symbol based on the weighted average of the first value and the second value.

A method, process, apparatus, a TV, a set-top box, a cell phone, a tablet, medium storing instructions, medium storing data, a syntax element, a bitstream, or signal may be used for one or more of encoding, decoding, storing, displaying, transmitting, and/or receiving data according to one or more of the examples described herein. Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-32. (canceled)

33. A device for video decoding, comprising:
a processor configured to:
obtain a value for a first binarization symbol associated with video data;
obtain a probability value associated with the first binarization symbol;
obtain a probability value associated with a second binarization symbol associated with the video data based on the value associated with the first binarization symbol, the probability value associated with the first binarization symbol, and an error associated with the first binarization symbol, wherein the error indicates an inconsistency between the value associated with the first binarization symbol and the probability value associated with the first binarization symbol; and
decode the video data based on the probability value associated with the second binarization symbol.

34. The device of claim 33, wherein the processor is further configured to obtain a value for a third binarization symbol associated with the video data, and the probability value associated with the second binarization symbol is obtained further based on the value for the third binarization symbol associated with the video data.

35. The device of claim 33, wherein the first and second binarization symbols are associated with a context for entropy decoding, the probability value associated with the first binarization symbol is a context probability value associated with the context, and the probability value associated with the second binarization symbol is an updated context probability value associated with the context.

36. The device of claim 33, wherein the processor is configured to obtain a respective value for each of a predetermined number of consecutive binarization symbols comprising the first binarization symbol, and wherein the probability value associated with the second binarization symbol is obtained based on the respective value for each of the predetermined number of consecutive binarization symbols.

37. The device of claim 33, wherein the first binarization symbol is associated with a context for entropy decoding, wherein the processor is further configured to:
obtain a window size associated with the context, wherein the probability value associated with the second binarization symbol is obtained further based on the window size.

38. The device of claim 33, wherein the first and second binarization symbols are associated with an entropy decoding context for decoding the video data using context-based adaptive binary arithmetic coding (CABAC).

39. The device of claim 33, wherein the first and second binarization symbols are associated with a context for entropy decoding, the probability value associated with the first binarization symbol is a first context probability value associated with the context, the probability value associated with the second binarization symbol is an updated context probability value associated with the context, and the processor is configured to:
entropy decode a respective value for each of a first predetermined number of consecutive binarization symbols comprising the first binarization symbol; and
entropy decode a second predetermined number of consecutive binarization symbols based on the updated context probability value associated with the context.

40. A device for video encoding, comprising:
a processor configured to:
obtain a value for a first binarization symbol associated with video data;
obtain a probability value associated with the first binarization symbol;
obtain a probability value associated with a second binarization symbol associated with the video data based on the value associated with the first binarization symbol, the probability value associated with the first binarization symbol, and an error associated with the first binarization symbol, wherein the error indicates an inconsistency between the value associated with the first binarization symbol and the probability value associated with the first binarization symbol; and
encode the video data based on the probability value associated with the second binarization symbol.

41. The device of claim 40, wherein the processor is further configured to obtain a value for a third binarization symbol associated with the video data, and the probability value associated with the second binarization symbol is obtained further based on the value for the third binarization symbol associated with the video data.

42. The device of claim 40, wherein the first and second binarization symbols are associated with a context for entropy decoding, the probability value associated with the first binarization symbol is a context probability value associated with the context, and the probability value associated with the second binarization symbol is an updated context probability value associated with the context.

43. The device of claim 40, wherein the processor is configured to obtain a respective value for each of a predetermined number of consecutive binarization symbols comprising the first binarization symbol, and wherein the probability value associated with the second binarization symbol is obtained based on the respective value for each of the predetermined number of consecutive binarization symbols.

44. The device of claim 40, wherein the first binarization symbol is associated with a context for entropy decoding, wherein the processor is further configured to:
obtain a window size associated with the context, wherein the probability value associated with the second binarization symbol is obtained further based on the window size.

45. A method for video decoding, comprising:
obtaining a value for a first binarization symbol associated with video data;
obtaining a probability value associated with the first binarization symbol;
obtaining a probability value associated with a second binarization symbol associated with the video data based on the value associated with the first binarization symbol, the probability value associated with the first binarization symbol, and an error associated with the first binarization symbol, wherein the error indicates an inconsistency between the value associated with the first binarization symbol and the probability value associated with the first binarization symbol; and
decoding the video data based on the probability value associated with the second binarization symbol.

46. The method of claim 45, further comprising obtaining a value for a third binarization symbol associated with the video data, and the probability value associated with the second binarization symbol is obtained further based on the value for the third binarization symbol associated with the video data.

47. The method of claim 45, wherein the first and second binarization symbols are associated with a context for entropy decoding, the probability value associated with the first binarization symbol is a context probability value associated with the context, and the probability value associated with the second binarization symbol is an updated context probability value associated with the context.

48. The method of claim 45, further comprising obtaining a respective value for each of a predetermined number of consecutive binarization symbols comprising the first binarization symbol, and wherein the probability value associated with the second binarization symbol is obtained based on the respective value for each of the predetermined number of consecutive binarization symbols.

49. The method of claim 45, wherein the first binarization symbol is associated with a context for entropy decoding, wherein the method comprises:
obtaining a window size associated with the context, wherein the probability value associated with the second binarization symbol is obtained further based on the window size.

50. A method for video encoding, comprising:
obtaining a value for a first binarization symbol associated with video data;
obtaining a probability value associated with the first binarization symbol;
obtaining a probability value associated with a second binarization symbol associated with the video data based on the value associated with the first binarization symbol, the probability value associated with the first binarization symbol, and an error associated with the first binarization symbol, wherein the error indicates an inconsistency between the value associated with the first binarization symbol and the probability value associated with the first binarization symbol; and
encoding the video data based on the probability value associated with the second binarization symbol.

51. The method of claim 50, further comprising obtaining a value for a third binarization symbol associated with the video data, and the probability value associated with the second binarization symbol is obtained further based on the value for the third binarization symbol associated with the video data.

52. The method of claim 50, wherein the first and second binarization symbols are associated with a context for entropy decoding, the probability value associated with the first binarization symbol is a context probability value associated with the context, and the probability value associated with the second binarization symbol is an updated context probability value associated with the context.
